(19) United States
(12) Patent Application Publication
(10) Pub. No.: US 2025/0318687 A1
(43) Pub. Date: Oct. 16, 2025

(54) BLEND CHAMBER DOOR

(71) Applicant: f'Real! Foods, LLC, Emeryville, CA (US)

(72) Inventor: Steven Thomas Connell, Oakland, CA (US)

(21) Appl. No.: 18/637,327

(22) Filed: Apr. 16, 2024

(51) Int. Cl. A47J 43/07; A47J 43/044

(52) U.S. Cl. CPC A47J 43/07; A47J 43/044; A47J 2043/04454

(57) ABSTRACT

A blender includes housing and a blend chamber disposed within the housing. The blend chamber includes an upper portion, a lower portion including an opening, and a door rotatably coupled to the blend chamber. The door includes a plate configured to selectively close the opening and a hinge about which the door is rotatable. The door is rotatable between a closed position, in which the plate seals the opening, and an open position. When the door is in the open position, the plate is disposed within the blend chamber. The hinge is coupled to the blend chamber on an opposite side of the opening as the plate.

### BACKGROUND

The present disclosure relates to food preparation machines, such as electrical blenders for preparing smoothies, milkshakes, protein shakes, and other blended beverages, and in particular, to blend chambers of such food preparation machines in which preparation of the food takes place.

### SUMMARY

In one aspect, the present disclosure provides a blender for blending food or beverage in a cup. The blender includes a housing, a cup holder movably coupled to the housing between a lowered position and a raised position, the cup holder configured to support the cup during blending, a blending mechanism including a rotatable cutting blade configured to blend the food or beverage in the cup, and a blend chamber disposed within the housing. The blend chamber includes an upper portion in which the blending mechanism is disposed, a lower portion including an opening through which the cup holder extends when in the raised position, and a door rotatably coupled to the blend chamber. The door includes a plate configured to selectively close the opening and a hinge about which the door is rotatable. The door is rotatable between a closed position in which the plate seals the opening and an open position. When the door is in the open position, the plate is disposed within the blend chamber. The hinge is coupled to the blend chamber on an opposite side of the opening as the plate.

In some embodiments, the blend chamber defines an interior cavity, and the hinge is coupled to the blend chamber outside of the interior cavity.

In some embodiments, the blend chamber includes a drain disposed adjacent to a rear wall of the blend chamber.

In some embodiments, the plate is disposed above the drain when the door is in the open position.

In some embodiments, the door rotates an amount less than 90 degrees between the open position and the closed position.

In some embodiments, the door is disposed at an angle relative to horizontal when in the closed position.

In another aspect, the present disclosure provides a blender for blending food or beverage in a cup. The blender includes a housing, a cup holder movably coupled to the housing between a lowered position and a raised position, the cup holder configured to support the cup during blending, a blending mechanism including a rotatable cutting blade configured to blend the food or beverage in the cup, and a blend chamber disposed within the housing. The blend chamber defines an interior cavity and includes an upper portion in which the blending mechanism is disposed, a lower portion including an opening through which the cup holder extends when in the raised position, and a door rotatably coupled to the blend chamber. The door includes a plate configured to selectively close the opening. The lower portion includes a bottom wall in which the opening is located, and the bottom wall slopes downward toward a rear of the blend chamber.

In some embodiments the door is rotatable between an open position and a closed position, and the plate is aligned with the bottom wall when in the closed position.

In some embodiments, the door rotates less than 90 degrees between the open position and the closed position.

In some embodiments, a seal coupled to one of the door or the bottom wall. The seal is configured to prevent liquid from passing through the opening when the door is in the closed position.

In some embodiments, the door includes a hinge configured to rotatably couple the door to the blend chamber, and the hinge is offset from the plate such that the hinge is coupled to the blend chamber outside of the interior cavity and the plate is disposed within the interior cavity.

In some embodiments, the door further includes an arm extending between the plate and the hinge.

In some embodiments, the arm is curved.

In some embodiments, the bottom wall includes a flange surrounding at least a portion of the opening and extending into the interior cavity of the blend chamber, and the plate includes a flange surrounding a perimeter of the plate.

In some embodiments, the flange of the plate is configured to engage with the flange of the bottom wall when the door is in the closed position.

In some embodiments, the bottom wall includes a channel extending around the opening adjacent to the flange.

In some embodiments, the blend chamber includes a drain disposed adjacent to the rear of the blend chamber, and the channel is configured to direct liquid around the opening and toward the drain.

In yet another aspect, the present disclosure provides a blender for blending food or beverage in a cup. The blender includes a housing, a cup holder movably coupled to the housing between a lowered position and a raised position, the cup holder configured to support the cup during blending, a blending mechanism including a rotatable cutting blade configured to blend the food or beverage in the cup, and a blend chamber disposed within the housing. The blend chamber defines an interior cavity and includes an upper portion in which the blending mechanism is disposed, a lower portion including an opening through which the cup holder extends when in the raised position, a door rotatably coupled to the blend chamber, and a drain configured to allow liquid to be expelled from the blend chamber. The door includes a plate configured to selectively close the opening. The lower portion includes a bottom wall in which the opening is located. The bottom wall slopes downward toward a rear of the blend chamber. The door is rotatable between a closed position in which the plate closes the opening and an open position in which the plate is positioned above the drain.

In some embodiments, the door rotates less than 90 degrees between the closed position and the open position.

In some embodiments, the door includes a hinge configured to rotatably couple the door to the blend chamber, and the hinge is coupled to the blend chamber adjacent to the drain.

In some embodiments, the blend chamber includes a seal disposed about the opening and configured to engage the door when the door is in the closed position.

Other embodiments of the disclosure will become apparent by consideration of the detailed description and accompanying drawings.

### BRIEF DESCRIPTION OF THE DRAWINGS

FIG. 1 is a perspective view of a blender.

FIG. 2 is a perspective view of the blender of FIG. 1, with a front door in an open position.

FIG. 3 is an upper perspective view of a blend chamber in accordance with the present disclosure.

FIG. 4 is a lower perspective view of the blend chamber.

FIG. 5 is a cross-sectional view of the blender chamber, taken along section line 5-5 in FIG. 3, illustrating a door of the blend chamber in an open position.

FIG. 6 is a cross-sectional view of the blend chamber, taken along section line 6-6 in FIG. 3, illustrating a door of the blend chamber in a closed position.

FIG. 7 is a cross sectional view of the blend chamber, taken along section line 7-7 in FIG. 3, with the door hidden for clarity.

FIG. 8 is an upper perspective view of the door of the blend chamber.

FIG. 9 is a lower perspective view of the door of the blend chamber.

### DETAILED DESCRIPTION

Before any implementations of the disclosure are explained in detail, it is to be understood that the disclosure is not limited in its application to the details of construction and arrangement of components set forth in the following description or illustrated in the following drawings. The disclosure is capable of other implementations and of being practiced or being carried out in various ways.

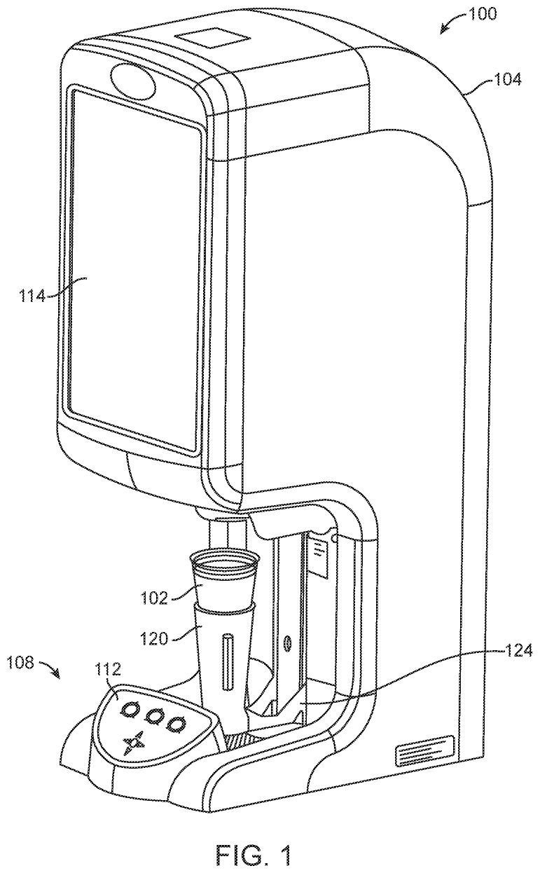

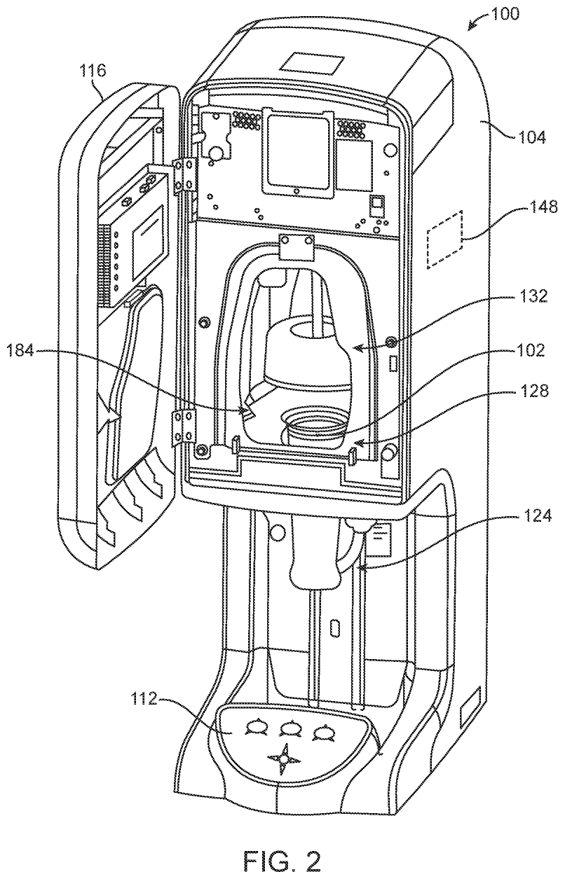

FIGS. 1 and 2 illustrate a food preparation machine or a blender 100 in accordance with the present disclosure. The blender 100 is adapted to prepare a food product, such as a frozen milkshake or a smoothie, within a cup 102. In other embodiments, the blender 100 may be utilized to prepare other types of food products. The blender 100 includes an external housing 104 to which a user interface 108 is coupled to. The user interface 108 of the illustrated embodiment is a control panel 112. The user interface 108 also includes a screen 114, such as a touch screen or video screen. The user interface 108 provides a user with information and the ability to control the blender 100 (e.g., to select a desired thickness of the blended food product). In the illustrated embodiment, the housing 104 further includes an access door 116 (FIG. 2) that selectively provides access to components of the blender 100 located within the housing 104 (e.g., access for maintenance). The blender 100 further includes a cup holder 120 to support the cup 102 and an elevator assembly 124 coupled to the cup holder 120 to raise and lower the cup 102. A blend chamber 128 is disposed within the housing 104 and contains a blending mechanism 132 therein. The blending mechanism 132 of the illustrated embodiment includes, in part, a rotating cutting blade 136 coupled to a motor (not shown). The rotating cutting blade 136 is supported by a shaft 140 that transmits rotational energy to the rotating cutting blade 136 (e.g., from the electric motor) and is adapted to raise and lower the rotating cutting blade 136 during blending. The blending mechanism 132 further includes a lid 142 that engages the cup 102 during blending to inhibit the food product being blended from splashing or spilling out of the cup 102. The lid 142 engages a rim of the cup 102 and further serves to stabilize the cup 102 within the cup holder 120 during the blending process. The lid 142 may be weighted or biased into engagement with the cup 102 by a spring 144 during the blending process. Finally, the blender 100 includes a rinsing and sanitizing system 148 operable to clean and sanitize the blending mechanism 132 and the blend chamber 128 after the blending process.

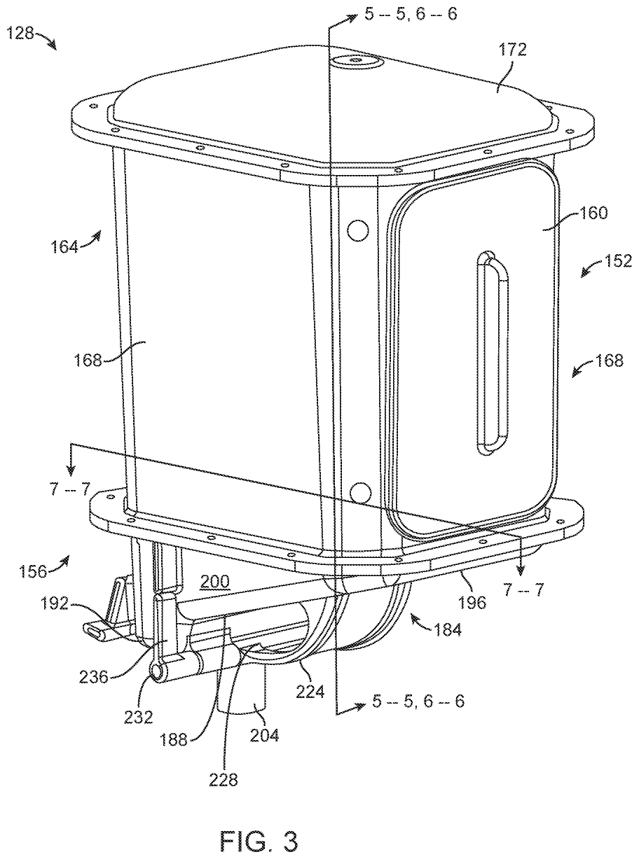

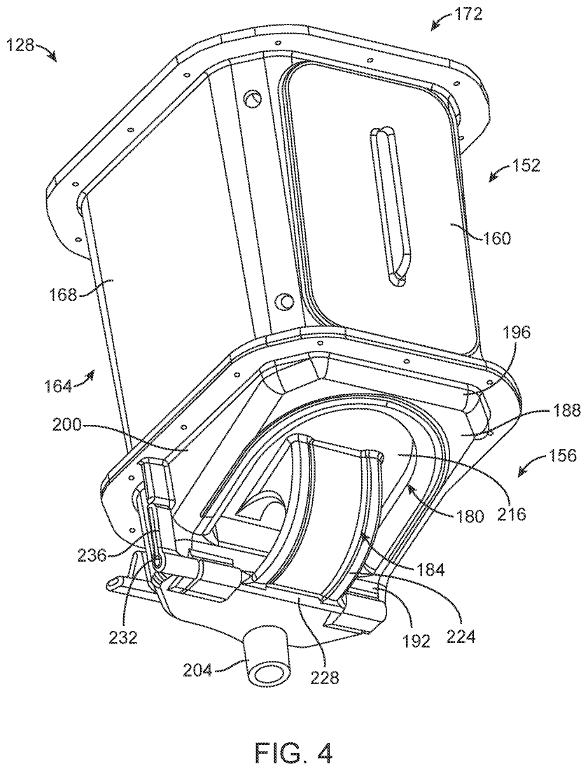

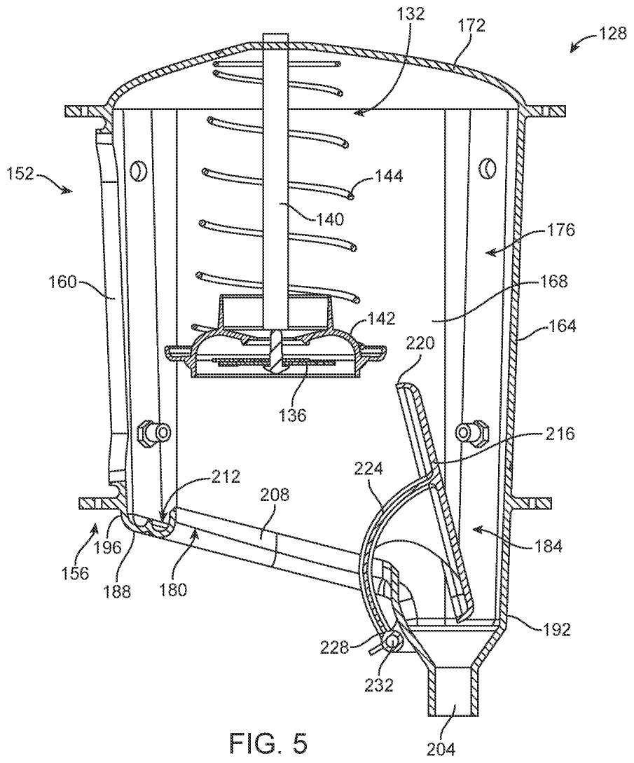

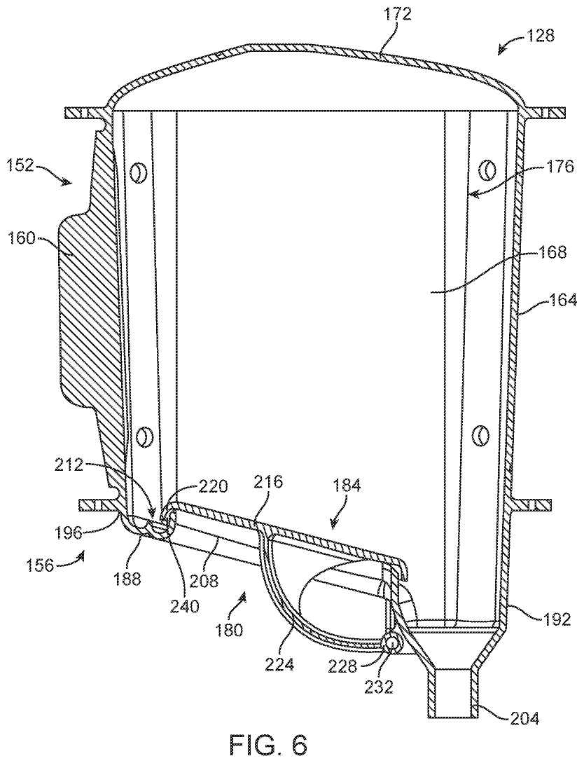

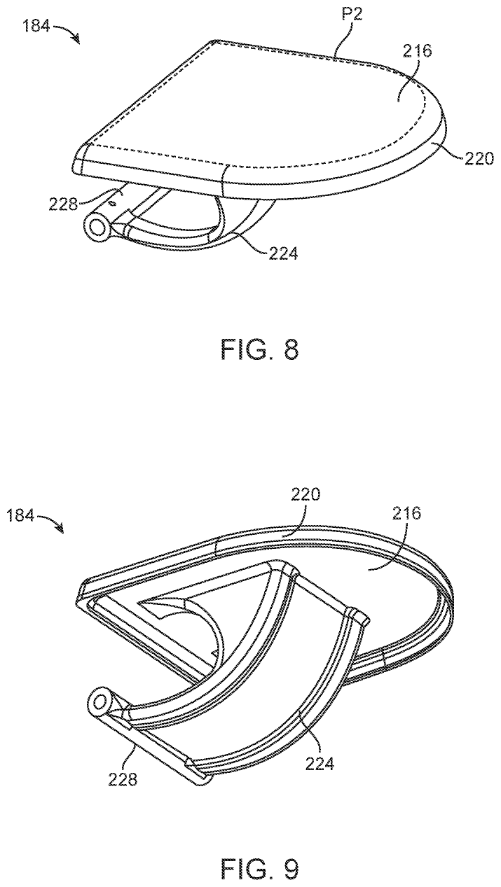

FIGS. 3-9 illustrate an embodiment of the blend chamber 128 in further detail. The blend chamber 128 includes an upper portion 152 and a lower portion 156. The upper portion 152 includes a forward wall 160, a rearward wall 164 opposite the forward wall 160, and a pair of opposed side walls 168 extending between the forward wall 160 and the rearward wall 164. An upper wall 172 is coupled to the forward, rearward, and opposed side walls 160, 164, 168 to define a roof of the blend chamber 128. In some embodiments, the forward wall 160 may include an access panel or door (not shown) to provide access to an interior of the blend chamber for maintenance. The blend chamber 128 of the illustrated embodiment defines a generally rectangular prism shaped interior cavity 176 in which the blending process takes place. However, it should be understood that the shape of the interior cavity 176 may vary based on the shape of the blender 100 or other design factors. The lower portion 156 of the blend chamber 128 includes an opening 180 to allow the elevator assembly 124 to raise the cup 102 into the blend chamber 128 prior to blending and to lower the cup 102 from the blend chamber 128 after blending. A door 184 is coupled to the lower portion 156 of the blend chamber 128 and is movable between an open position (FIG. 5) and a closed position (FIG. 6) to selectively close the blend chamber 128.

With reference to FIGS. 3-7, the lower portion 156 of the blend chamber 128 is shaped such that a bottom wall 188 in which the opening 180 is located is positioned at an angle. In particular, the lower portion 156 of the blend chamber 128 includes a rear wall 192 extending from the rearward wall 164 of the upper portion 152. The lower portion 156 of the blend chamber 128 further includes a front wall 196 extending from the forward wall 160 of the upper portion 152 of the blend chamber 128. The bottom wall 188 connects the rear wall 192 to the front wall 196. The lower portion 156 of the blend chamber 128 further includes a pair of opposed side walls 200 that are generally triangular in shape. The rear wall 192 extends downwards further from the upper portion 152 of the blend chamber 128 than the front wall 196, thus defining the angle of the bottom wall 188. In other words, the bottom wall 188 slopes downwards toward the rear of the blend chamber 128. In the illustrated embodiment, the blend chamber 128 includes a drain 204 disposed within the bottom wall 188 adjacent to the rear wall 192. The drain 204 allows for liquid (e.g., from the rinsing and sanitizing system 148) to be collected and expelled from the blend chamber.

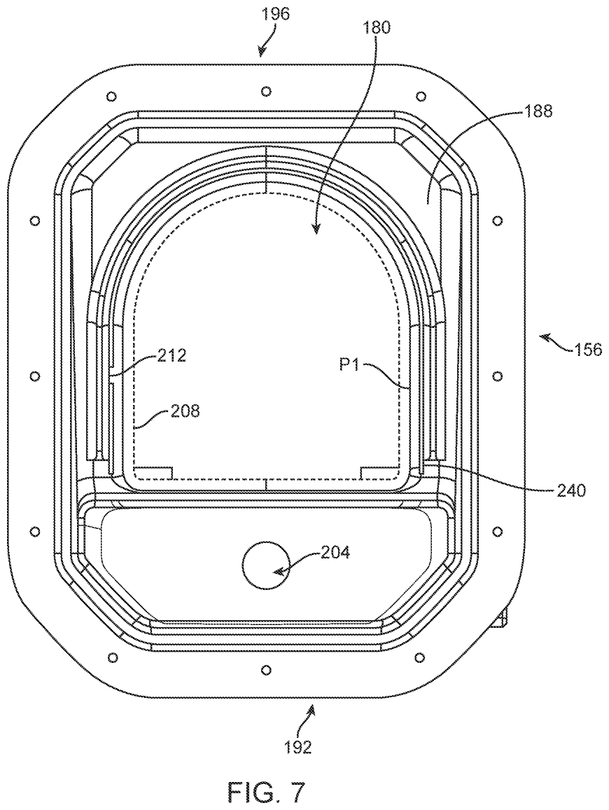

With continued reference to FIGS. 3-7, the opening 180 defines a majority of the bottom wall 188. A perimeter P1 of the opening 180 is defined by a flange 208 extending into the interior cavity 176 of the blend chamber 128 from the bottom wall 188. The opening 180 is shaped such that a portion of the perimeter P1 adjacent to the rear wall 192 is linear and a portion of the perimeter P1 adjacent to the front wall 196 is curved. In other embodiments, the perimeter P1 of the opening 180 may be differently shaped based on the shape of the blend chamber 128. Referring now to FIG. 7, a channel 212 formed as a recess in the bottom wall 188 extends around a portion of the perimeter P1 of the opening 180. In the illustrated embodiment, the channel 212 does not extend along the portion of the perimeter P1 adjacent to the rear wall 192. The channel 212 and the flange 208 serve to direct liquid toward the drain 204 and to engage with the door 184 to close the blend chamber 128, as will be described in greater detail herein.

Further details of the door 184 will now be provided with reference to FIGS. 3-6, 8, and 9. The door 184 is coupled to the lower portion 156 of the blend chamber 128 and rotatable between an open position (FIG. 5) and a closed position (FIG. 6). When moving from the closed position toward the open position, the door 184 rotates into the interior cavity 176 of the blend chamber 128. The door 184 includes a plate 216 corresponding in shape to the opening 180. A flange 220 extends downwards from a perimeter P2 of the plate 216. When the door 184 is in the closed position, the flange 220 of the door 184 engages with the flange 208 of the bottom wall 188 to close the opening (FIG. 6). The flange 220 of the door 184 is disposed outside of the flange 208 of the bottom wall 188 when the door 184 is in the closed position. In other words, the perimeter P2 of the plate 216 is larger than the perimeter P1 of the opening 180. An arm 224 extends from the plate 216 and terminates at a hinge 228. In the illustrated embodiment, the arm 224 is curved downwards and rearwards to locate the hinge 228 adjacent to the rear wall 192 and to the drain 204. The curved shape of the arm 224 provides an offset between the plate 216 and the hinge 228. The offset provides clearance between the door 184 and the blend chamber 128 when the door 184 is rotated to the open position. The hinge 228 of the illustrated embodiment includes a pivot pin 232 that is coupled to the blend chamber 128 outside of the interior cavity 176 and an actuator 236 coupled to the pivot pin 232. The actuator 236 is adapted to selectively induce rotation of the door 184 between the closed position and the open position.

When the door 184 is in the closed position, the door 184 closes the opening 180 of the blend chamber 128. In some embodiments, sealing material 240 may be disposed on the door 184, about the opening 180, or both to aid in closing the opening 180. The angle of the bottom wall 188, and thus the door 184 when closed, prevents shearing of the sealing material as the door 184 is closed and engages with the bottom wall 188. Furthermore, due to the angle of the bottom wall 188, the door 184 rotates less than 90 degrees between the closed position and the open position.

When the door 184 is in the open position, the plate 216 is rotated upwards into the interior cavity 176 of the blend chamber 128 and towards the rearward wall 164. Thus, the plate 216 is positioned above the drain 204 when in the open position and any liquid on the door plate 216 is directed into the drain 204, rather than through the opening 180.

In operation, a cup 102 containing a food product to be blended is placed within the cup holder 120. The door 184 to the blend chamber 128 is rotated to the open position if not already there, and the cup holder 120 is raised, such that the cup 102 is located within the blend chamber 128. The blending mechanism 132 then acts on the food product within the cup 102. After blending, the cup holder 120 is lowered such that a user can retrieve the cup 102, and the door 184 is rotated to the closed position. The rinsing and sanitizing system 148 then acts on the blending mechanism 132 and the interior cavity 176 of the blend chamber 128 to clean and sanitize the blender 100. The door 184 seals the opening 180 such that no liquid escapes the blend chamber 128 during cleaning and sanitizing. After cleaning and sanitizing, the door 184 may be rotated to the open position to prepare for a subsequent blending process. The channel 212 around the opening 180 directs any remaining liquid towards the drain 204, and the location of the door 184 above the drain 204 when in the open position allows any liquid remaining on the plate 216 to drip into the drain 204, rather than through the opening 180.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, one having ordinary skill in the art will appreciate that specific features of the numerous embodiments disclosed may be mixed and matched in other ways where not specifically inhibited, even though specific illustration of such embodiments may not be exhaustively covered herein.

Various features of the disclosure are set forth in the following claims.

What is claimed is:

1. A blender for blending food or beverage in a cup, the blender comprising:
a housing;
a cup holder movably coupled to the housing between a lowered position and a raised position, the cup holder configured to support the cup during blending;
a blending mechanism including a rotatable cutting blade configured to blend the food or beverage in the cup; and
a blend chamber disposed within the housing, the blend chamber including
an upper portion in which the blending mechanism is disposed,
a lower portion including an opening through which the cup holder extends when in the raised position, and
a door rotatably coupled to the blend chamber, the door including a plate configured to selectively close the opening and a hinge about which the door is rotatable,
wherein the door is rotatable between a closed position, in which the plate seals the opening, and an open position,
wherein, when the door is in the open position, the plate is disposed within the blend chamber, and
wherein the hinge is coupled to the blend chamber on an opposite side of the opening as the plate.

2. The blender of claim 1, wherein the blend chamber defines an interior cavity, and wherein the hinge is coupled to the blend chamber outside of the interior cavity.

3. The blender of claim 1, wherein the blend chamber includes a drain disposed adjacent to a rear wall of the blend chamber.

4. The blender of claim 3, wherein the plate is disposed above the drain when the door is in the open position.

5. The blender of claim 1, wherein the door rotates an amount less than 90 degrees between the open position and the closed position.

6. The blender of claim 5, wherein the door is disposed at an angle relative to horizontal when in the closed position.

7. A blender for blending food or beverage in a cup, the blender comprising:
a housing;
a cup holder movably coupled to the housing between a lowered position and a raised position, the cup holder configured to support the cup during blending;
a blending mechanism including a rotatable cutting blade configured to blend the food or beverage in the cup; and
a blend chamber disposed within the housing, the blend chamber defining an interior cavity and including
an upper portion in which the blending mechanism is disposed,
a lower portion including an opening through which the cup holder extends when in the raised position, and
a door rotatably coupled to the blend chamber, the door including a plate configured to selectively close the opening,
wherein the lower portion includes a bottom wall in which the opening is located, and
wherein the bottom wall slopes downward toward a rear of the blend chamber.

8. The blender of claim 7, wherein the door is rotatable between an open position and a closed position, and wherein the plate is aligned with the bottom wall when in the closed position.

9. The blender of claim 8, wherein the door rotates less than 90 degrees between the open position and the closed position.

10. The blender of claim 8, further comprising a seal coupled to one of the door or the bottom wall, the seal configured to prevent liquid from passing through the opening when the door is in the closed position.

11. The blender of claim 7, wherein the door includes a hinge configured to rotatably couple the door to the blend chamber, and wherein the hinge is offset from the plate such that the hinge is coupled to the blend chamber outside of the interior cavity and the plate is disposed within the interior cavity.

12. The blender of claim 11, wherein the door further includes an arm extending between the plate and the hinge.

13. The blender of claim 7, wherein the bottom wall includes a flange surrounding at least a portion of the opening and extending into the interior cavity of the blend chamber, and wherein the plate includes a flange surrounding a perimeter of the plate.

14. The blender of claim 13, wherein the flange of the plate is configured to engage with the flange of the bottom wall when the door is in the closed position.

15. The blender of claim 13, wherein the bottom wall includes a channel extending around the opening adjacent to the flange.

16. The blender of claim 15, wherein the blend chamber includes a drain disposed adjacent to the rear of the blend chamber, and wherein the channel is configured to direct liquid around the opening and toward the drain.

17. A blender for blending food or beverage in a cup, the blender comprising:
a housing;
a cup holder movably coupled to the housing between a lowered position and a raised position, the cup holder configured to support the cup during blending;
a blending mechanism including a rotatable cutting blade configured to blend the food or beverage in the cup; and
a blend chamber disposed within the housing, the blend chamber defining an interior cavity and including
an upper portion in which the blending mechanism is disposed,
a lower portion including an opening through which the cup holder extends when in the raised position,
a door rotatably coupled to the blend chamber, the door including a plate configured to selectively close the opening, and
a drain configured to allow liquid to be expelled from the blend chamber,
wherein the lower portion includes a bottom wall in which the opening is located,
wherein the bottom wall slopes downward toward a rear of the blend chamber, and
wherein the door is rotatable between a closed position in which the plate closes the opening and an open position in which the plate is positioned above the drain.

18. The blender of claim 17, wherein the door rotates less than 90 degrees between the closed position and the open position.

19. The blender of claim 17, wherein the door includes a hinge configured to rotatably couple the door to the blend chamber, and wherein the hinge is coupled to the blend chamber adjacent to the drain.

20. The blender of claim 17, wherein the blend chamber includes a seal disposed about the opening and configured to engage the door when the door is in the closed position.
